(19) United States
(12) Patent Application Publication
(10) Pub. No.: US 2012/0121163 A1
(43) Pub. Date: May 17, 2012

(54) 3D DISPLAY APPARATUS AND METHOD FOR EXTRACTING DEPTH OF 3D IMAGE THEREOF

(75) Inventors: Lei ZHANG, Suwon-si (KR); Jong-sul MIN, Suwon-si (KR); Oh-jae KWON, Suwon-si (KR)

(73) Assignee: SAMSUNG ELECTRONICS CO., LTD., Suwon-si (KR)

(21) Appl. No.: 13/244,317

(22) Filed: Sep. 24, 2011

(30) Foreign Application Priority Data
Nov. 15, 2010 (KR) 10-2010-0113553
Jan. 19, 2011 (KR) 10-2011-0005572

(51) Int. Cl. G06K 9/00; G06T 15/00

(52) U.S. Cl. 382/154; 345/419

(57) ABSTRACT

A three-dimensional (3D) display apparatus and a method for extracting a depth of a 3D image of the 3D display apparatus are provided. The 3D display apparatus includes: an image input unit which receives an image; a 3D image generator which generates a 3D image of which a depth is adjusted according to a relative motion between global and local motions of the image; and an image output unit which outputs the 3D image.

### CROSS-REFERENCE TO RELATED APPLICATION

This application claims priority from Korean Patent Applications No. 10-2010-0113553, filed on Nov. 15, 2010 and No. 10-2011-0005572, filed on Jan. 19, 2011 in the Korean Intellectual Property Office, the disclosure of which is incorporated herein by reference in its entirety.

### BACKGROUND

1. Field

Apparatuses and methods consistent with exemplary embodiments relate to a three-dimensional (3D) display apparatus and a method for extracting a depth of a 3D image thereof, and more particularly, to a 3D display apparatus which alternately displays left and right eye images and a method for extracting a depth of a 3D image thereof.

2. Description of the Related Art

3D image technology is applied in the various fields such as information communication, broadcasting, medical care, education and training, the military, games, animations, virtual reality, computer-aided design (CAD), industrial technology, etc. The 3D image technology is regarded as core technology of next-generation 3D multimedia information communication which is commonly required in these various fields.

In general, a 3D effect perceived by a human is generated by compound actions of a thickness change degree of a lens caused by changes in a position of an object which is to be observed, an angle difference between both eyes and the object, differences in a position and a shape of the object seen by left and right eyes, a disparity caused by a motion of the object, and other various psychological and memory effects, etc.

Among the above-described factors, a binocular disparity occurring due to a horizontal distance from about 6 cm to about 7 cm between left and right eyes of a human viewer is regarded as the most important factor of the 3D effect. In other words, the viewer sees an object with angle differences due to a binocular disparity, and an image entering left and right eyes has two different images due to the angle differences. When the two different images are transmitted to the viewer's brain through retinas, the brain accurately unites information of the two different images so that the viewer perceives an original 3D image.

An adjustment of a 3D effect of a 3D image in a 3D display apparatus is a very important operation. If the 3D effect of the 3D image is too low, a user views the 3D image like a two-dimensional (2D) image. If the 3D effect of the 3D image is too high, the user cannot view the 3D image for a long time due to fatigue.

In particular, the 3D display apparatus adjusts a depth of the 3D image in order to create the 3D effect of the 3D image. Examples of a method for adjusting the depth of the 3D image include: a method of constituting the depth of the 3D image using spatial characteristics of the 3D image; a method of acquiring the depth of the 3D image using motion information of an object included in the 3D image; a method of acquiring the depth of the 3D image through combinations thereof, etc.

If the depth of the 3D image is extracted according to the motion information of the object of the 3D image, the 3D display apparatus extracts the depth, so that a fast moving object looks like close to a viewer, and a slowly moving object looks like distant from the viewer.

However, if an object does not move, but only a background moves, an image distortion, in which the background looks closer to the viewer than the object, occurs.

Also, if an object moves and then suddenly stops moving in one background, a depth value is extracted up to a scene in which the object moves. However, a depth value is not extracted from a scene in which the object stops its movement. In other words, although the object stops moving, the object is to have the same depth value as that obtained when the object moves, but the depth value is not extracted. Therefore, a depth value of an object in a screen is suddenly changed.

Accordingly, a method for extracting a depth of a 3D image is required to provide a 3D image having an accurate 3D effect.

### SUMMARY

One or more exemplary embodiments may overcome the above disadvantages and/or other disadvantages not described above. However, it is understood that one or more exemplary embodiment are not required to overcome the disadvantages described above, and may not overcome any of the problems described above.

One or more exemplary embodiments provide a 3D display apparatus which adjusts a depth of a 3D image according to a relative motion between global and local motions of an input image and a method for extracting the depth of the 3D image of the 3D display apparatus.

According to an aspect of an exemplary embodiment, there is provided a 3D display apparatus. The 3D display apparatus may include: an image input unit which receives an image; a 3D image generator which generates a 3D image using a depth which is adjusted according to a relative motion between global and local motions of the image; and an image output unit which outputs the 3D image.

The 3D image generator may include: a motion analyzer which extracts global motion information and local motion information of the image; a motion calculator which calculates the relative motion using an absolute value of a difference between the global motion information and the local motion information; and a motion depth extractor which extracts a motion depth according to the relative motion.

The 3D image generator may further include a motion depth adjuster which adjusts reliability of the motion depth according to at least one of the global motion information and the local motion information which are extracted by the motion analyzer.

The 3D image generator may generate a depth map using the motion depth and, if the reliability of the motion depth is lower than or equal to a specific threshold value, may perform smoothing of the depth map.

The motion depth adjuster may lower the reliability of the motion depth with an increase in the global motion and may increase the reliability of the motion depth with a decrease in the global motion.

If the global motion becomes greater only in a specific area of a screen, the motion depth adjuster may lower reliability of a depth of the specific area.

The motion depth extractor may extract the motion depth of the 3D image according to a location and an area of an object comprised in the image.

If the global and location motions do not exist, the motion depth extractor may extract the motion depth using a motion depth value of a previous frame.

The 3D image generator may further include: a basic depth extractor which extracts a basic depth of the 3D image using spatial characteristics of the image; and a depth map generator which mixes the motion depth extracted by the motion depth extractor with the basic depth extracted by the basic depth extractor to generate the depth map.

The 3D image generator may further include: a basic depth extractor which extracts a basic depth of the 3D image using spatial characteristics of the image; and a depth map generator which, if a change degree of the image is higher than or equal to a specific threshold value, generates the depth map using the basic depth without reflecting the motion depth.

The image may be a 2D image.

The image may be a 3D image, and the 3D image generator may generate a 3D image of which depth has been adjusted according to a relative motion, using a left or right eye image of the 3D image.

According to an aspect of another exemplary embodiment, there is provided a method for extracting a depth of a 3D image of a 3D display apparatus. The method may include: receiving an image; generating a 3D image of which depth has been adjusted according to a relative motion between global and local motions of the image; and outputting the 3D image.

The generation of the 3D image may include: extracting global motion information and local motion information of the image; calculating a relative motion using an absolute value of a difference between the global motion information and the local motion information; and extracting a motion depth according to the relative motion.

The generation of the 3D image may further include adjusting reliability of the motion depth according to at least one of the global motion information and the local motion information.

The method may further include generating a depth map using the motion depth. If the reliability of the motion depth is lower than or equal to a specific value, the generation of the depth map may include performing smoothing of the depth map.

The adjustment of the reliability of the motion depth may include: lowering the reliability of the motion depth with an increase in the global motion and increasing the reliability of the motion depth with a decrease in the global motion.

The adjustment of the reliability of the motion depth may include: if the global motion becomes greater only in a specific area of a screen, lowering reliability of a depth of the specific area.

The extraction of the motion depth may include extracting a motion depth of a 3D image according to a location and an area of an object comprised in the image.

The extraction of the motion depth may include: if the global and location motions do not exist, extracting the motion depth using a motion depth value of a previous frame.

The generation of the 3D image may further include: extracting a basic depth of the 3D image using spatial characteristics of the image; and mixing the motion depth with the basic depth to generate a depth map of a 3D image.

The generation of the 3D image may further include: extracting a basic depth of the 3D image using spatial characteristics of the image; and if a change degree of the image is higher than or equal to a specific threshold value, generating the depth map using the basic depth without reflecting the motion depth.

The image may be a 2D image.

The image may be a 3D image, and the generation of the 3D image may include generating a 3D image of which depth has been adjusted according to a relative motion, using a left or right eye image of the 3D image.

Additional aspects and/or advantages of the exemplary embodiments will be set forth in the detailed description, will be obvious from the detailed description, or may be learned by practicing the exemplary embodiments.

### BRIEF DESCRIPTION OF THE DRAWING FIGURES

The above and/or other aspects will be more apparent by describing in detail exemplary embodiments, with reference to the accompanying drawings, in which:

FIG. 1 is a block diagram of a 3D display apparatus according to an exemplary embodiment;

FIG. 2 is a block diagram of a 3D image generator according to an exemplary embodiment;

FIGS. 3A and 3B are views illustrating a method for calculating a relative motion according to an exemplary embodiment;

FIGS. 4A and 4B are views illustrating a method for calculating a relative motion according to another exemplary embodiment;

FIG. 5 is a view illustrating a method for extracting a depth value according to a location of an object according to an exemplary embodiment;

FIG. 6 is a view illustrating a method for extracting a depth value according to an area of an object according to an exemplary embodiment;

FIG. 7 is a view illustrating a method for extracting a depth value if a motion information value of an image is “0” according to an exemplary embodiment; and

FIG. 8 is a flowchart illustrating a method for extracting a depth of a 3D image of a 3D display apparatus, according to an exemplary embodiment.

### DETAILED DESCRIPTION OF THE EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the exemplary embodiments with unnecessary detail.

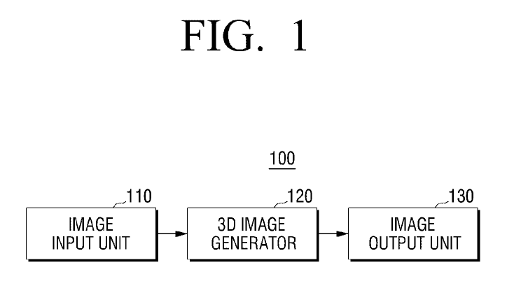

FIG. 1 is a block diagram of a 3D display apparatus 100 according to an exemplary embodiment. Referring to FIG. 1, the 3D display apparatus 100 includes an image input unit 110, a 3D image generator 120, and an image output unit 130.

The image input unit 110 receives an image from a broadcasting station or a satellite through a wire or wirelessly and demodulates the image. The image input unit 110 is connected to an external device, such as a camera or the like, to receive an image signal from the external device. The external device may be connected to the image input unit 110 wirelessly or with a wire through an interface such as a super-video (S-Video), a component, a composite, a D-subminiature (D-Sub), a digital visual interface (DVI), a high definition multimedia interface (HDMI), or the like.

In particular, the image signal input into the image input unit 110 may be a 2D image signal or a 3D image signal. If the image signal is the 3D image signal, the 3D image signal may have various formats. In particular, the 3D image signal may have a format that complies with one of a general frame sequence method, a top-bottom method, a side-by-side method, a horizontal interleaving method, a vertical interleaving method, and a checkerboard method.

The image input unit 110 transmits the image signal to the 3D image generator.

The 3D image generator 120 performs signal processing, such as video decoding, format analyzing, video scaling, etc., and jobs, such as graphic user interface (GUI) adding, etc., with respect to the image signal.

In particular, if a 2D image is input, the 3D image generator 120 respectively generates left and right eye images corresponding to the 2D image. If a 3D image is input, the 3D image generator 120 respectively generates left and right eye images corresponding to a size of one screen, using a format of a 3D image as described above.

When the 3D image generator 120 generates the left and right eye images, the 3D image generator 120 adjusts a depth of the image signal using motion information of a frame included in the image signal. In detail, the 3D image generator 120 extracts a motion depth using a relative motion between global and local motions in a screen of an image.

In more detail, the 3D image generator 120 calculates an absolute value of the relative motion between the global and local motions in the screen of the image and then calculates a motion depth of an object. The 3D image generator 120 extracts the motion depth in consideration of a location and an area of the object. The 3D image generator 120 calculates reliability of the motion depth according to the global motion and then adjusts the motion depth. The 3D image generator 120 mixes the motion depth with a basic depth, which is extracted according to spatial characteristics of a 3D image, to generate a depth map and then generates a 3D image of which depth has been adjusted according to the depth map. A method for extracting a depth of a 3D image according to an exemplary embodiment will be described in more detail later.

The 3D image generator 120 receives a GUI from a GUI generator (not shown) and adds the GUI to the left or right eye image or both of the left and right eye images.

The 3D image generator 120 time-divides the left and right eye images and alternately transmits the left and right eye images to the image output unit 130. In other words, the 3D image generator 120 transmits the left and right eye images to the image output unit 130 in a time order of a left eye image L1, a right eye image R1, a left eye image L2, a right eye image R2, . . . .

The image output unit 130 alternately outputs and provides the left and right eye images, which are output from the 3D image generator 120, to a user.

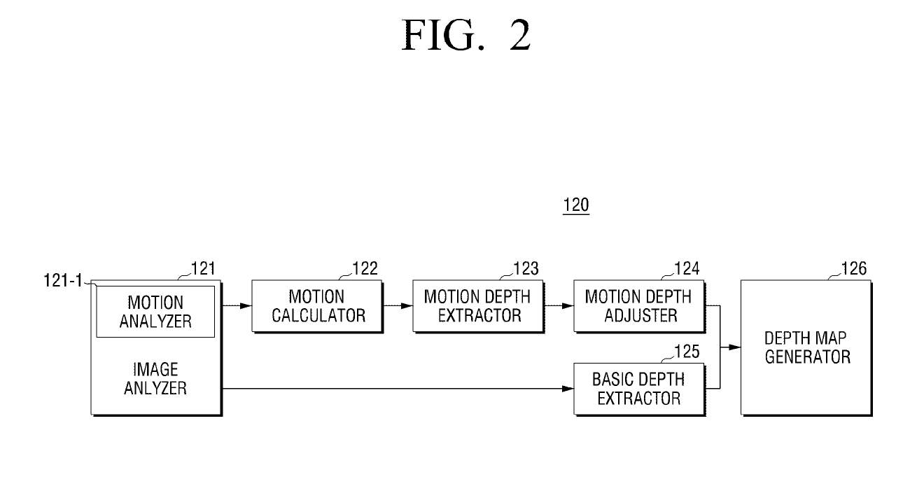

A method for extracting a depth of a 3D image of the 3D image generator 120 will now be described in more detail with reference to FIGS. 2 through 7.

FIG. 2 is a block diagram of the 3D image generator 120, according to an exemplary embodiment. Referring to FIG. 2, the 3D image generator 120 includes an image analyzer 121, a motion calculator 122, a motion depth extractor 123, a motion depth adjuster 124, a basic depth extractor 125, and a depth map generator 126.

The image analyzer 121 analyzes an input image. If a 2D image is input, the image analyzer 121 analyzes the 2D image. If a 3D image is input, the image analyzer 121 analyzes one or both of left and right eye images of the 3D image.

In particular, the image analyzer 121 detects spatial characteristics or background changes of the input image. In more detail, the image analyzer 121 analyzes a color, a contrast, an arrangement between objects, etc. of the input image, which are the spatial characteristics of the input image, and transmits the analyzed spatial characteristics to the basic depth extractor 125.

The image analyzer 121 detects whether a screen has suddenly changed. This is because a motion depth of the 3D image becomes a meaningless value if the screen has suddenly changed. The image analyzer 121 detects a change degree of the screen to determine whether the motion depth of the 3D image is to be calculated. If it is determined that the screen has suddenly changed, the 3D image display apparatus 100 does not calculate the motion depth but generates a depth map using only a basic depth. If it is determined that the screen has not suddenly changed, the 3D display apparatus 100 calculates the motion depth and then mixes the motion depth with the basic depth to generate the depth map. Here, whether the screen has suddenly changed may be calculated using a change degree of a pixel included in the screen of the 3D image.

The image analyzer 121 includes a motion analyzer 121-1 which analyzes motion information of the input image. The motion analyzer 121-1 extracts information (hereinafter referred to as global motion information) on a global motion of the input image and information (hereinafter referred to as local motion information) on a local motion of the input image. Here, the global motion refers to a motion of a background which moves according to a movement of a camera which captures an image. For example, the global motion may be a motion which is extracted according to a camera technique such as panning, zooming, or rotation. The motion analyzer 121-1 outputs the global motion information and the local motion information to the motion calculator 122.

The motion calculator 122 calculates a relative motion between the global and local motions using the global motion information and the local motion information output from the motion analyzer 121-1. Here, the motion calculator 122 calculates a relative motion parameter P as in Equation 1 below, using an absolute value of the relative motion between the global and local motions. The relative motion parameter P is used to extract a depth of an object as follows in Equation 1:

P=|v−v_{GM}| (1)

wherein P denotes the relative motion parameter, v denotes the local motion, and v_{GM} denotes the global motion.

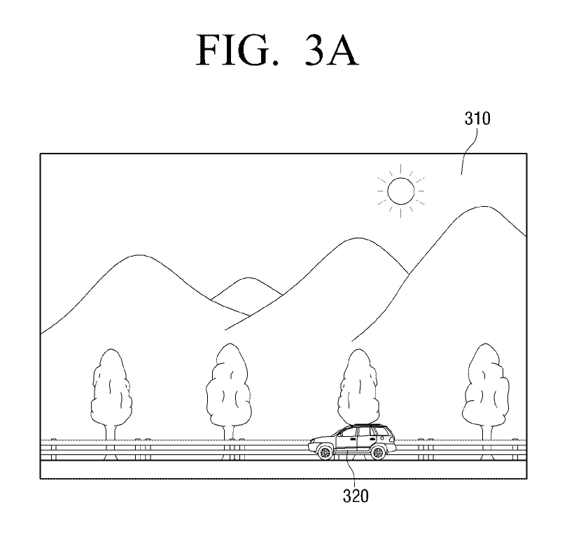

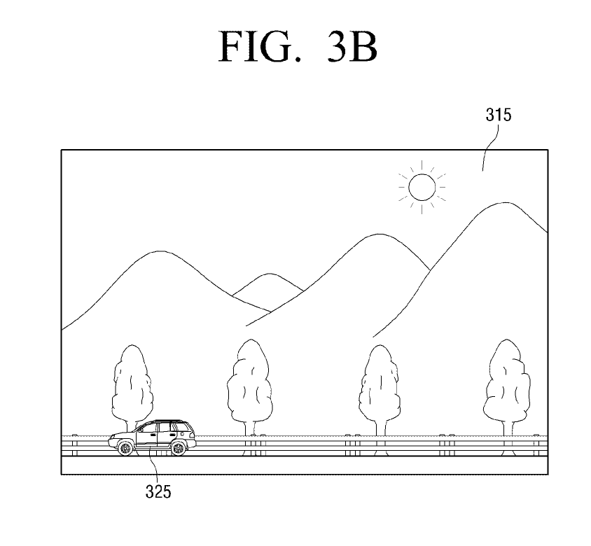

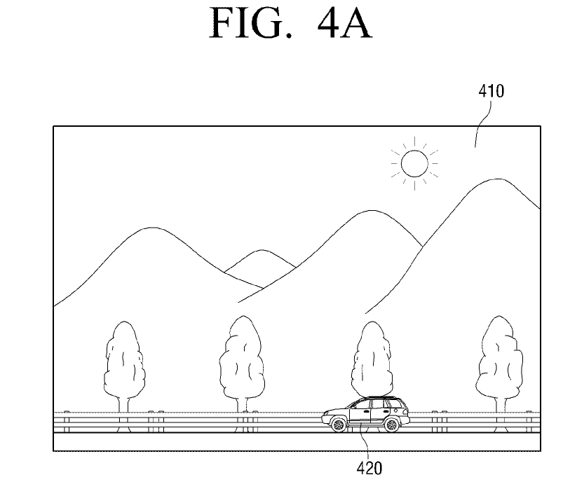

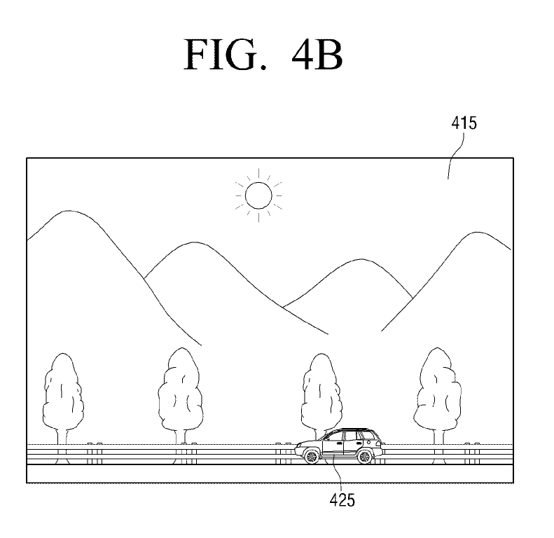

A method for calculating an absolute value of a relative motion between global and local motions will now be described in more detail with reference to FIGS. 3A through 4B.

FIGS. 3A and 3B are views illustrating a method for calculating a relative motion if an object moves, according to an exemplary embodiment.

Referring to FIGS. 3A and 3B, frames of images respectively include background 310 and 315 and objects 320 and 325. In a comparison between FIGS. 3A and 3B, there are no motions of the backgrounds 310 and 315, but there are motions of the objects 320 and 325. In other words, there are no global motions in screens of FIGS. 3A and 3B. Therefore, if these are expressed with numerical values, a global motion vGM is “0,” and a local motion v is “10.” Accordingly, if Equation 1 above is substituted for this, a relative motion parameter P is “10.”

FIGS. 4A and 4B are views illustrating a method for extracting a relative motion if a background moves, according to another exemplary embodiment.

Referring to FIGS. 4A and 4B, frames of images respectively include backgrounds 410 and 415 and objects 420 and 425. Comparing FIGS. 4A and 4B, there are no motions of the objects 420 and 425, but there are motions of the backgrounds 410 and 415. In other words, there are no local motions in screens of FIGS. 4A and 4B. Therefore, if movement speeds of the objects 420 and 425 of FIGS. 4A and 4B are equal to movement speeds of the backgrounds 410 and 415, and these are expressed with numerical values, a global motion is “10,” and a local motion is “0.” Therefore, if Equation 1 above is substituted for this, a relative motion parameter P is “10.”

In other words, when summarizing the contents of FIGS. 3A through 4B, in a related art method for extracting a relative motion, if an object moves (as shown in FIGS. 3A and 3B), a motion parameter is “10,” and thus the object looks ahead. If a background moves (as shown in FIGS. 4A and 4B), a motion parameter is “10,” and thus the background looks ahead.

However, according to the exemplary embodiment, if an object moves (as shown in FIGS. 3A and 3B) and a background moves (as shown in FIGS. 4A and 4B), a motion parameter is “10” in both cases. Therefore, the object looks ahead in both cases. Accordingly, if a motion depth is calculated using an absolute value of a relative motion between global and local motions, a 3D image of which 3D effect is not distorted is output.

The motion calculator 122 outputs the relative motion parameter P to the motion depth extractor 123.

The motion depth extractor 123 calculates a motion depth in consideration of the relative motion parameter P input from the motion calculator 122, and a location and an area of an object.

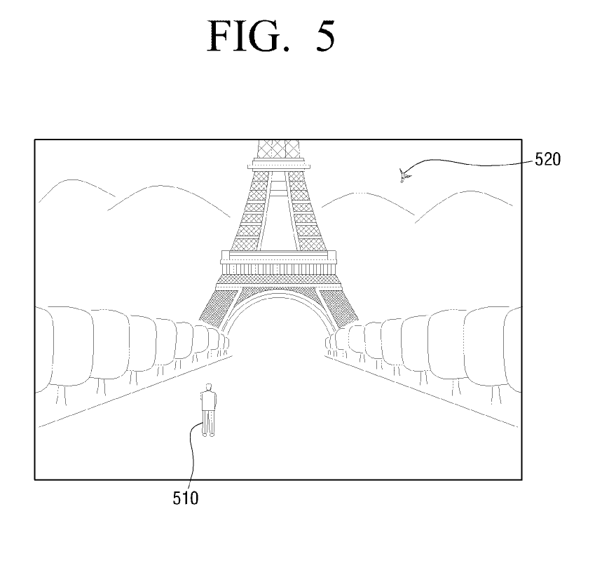

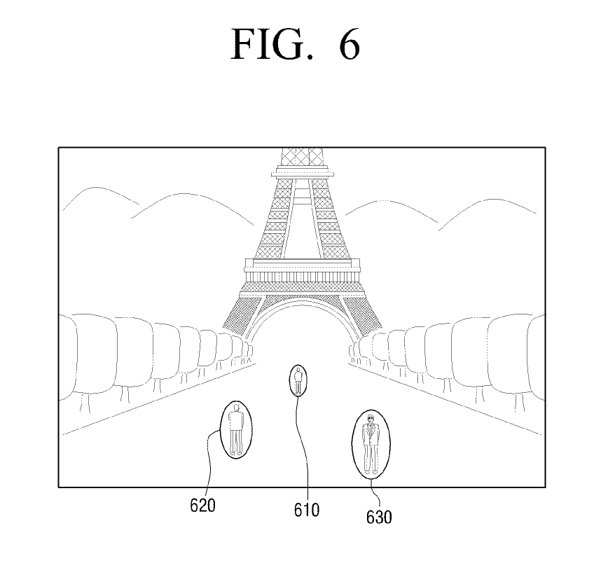

A method for extracting a motion depth in consideration of a location and an area of an object will now be described with reference to FIGS. 5 and 6.

FIG. 5 is a view illustrating a method for extracting a depth value according to a location of an object, according to an exemplary embodiment.

Referring to FIG. 5, a screen includes a first object 510 which is a human shape and a second object 520 which is a bird shape. Here, the first object 510 is located downwards to be close to the ground. The second object 520 is located upwards to be close to the sky. Therefore, the motion depth extractor 123 detects that a location parameter AP1 of the first object 510 is greater than a location parameter AP2 of the second object 520. For example, the motion depth extractor 123 detects the location parameter AP1 of the first object 510 as “10,” and the location parameter AP2 of the second object 520 as “5.”

FIG. 6 is a view illustrating a method for extracting a depth value according to an area of an object, according to an exemplary embodiment.

Referring to FIG. 6, a screen includes first, second, and third objects which are human shapes. An area 610 of the first object is narrowest, an area 630 of the third object is widest, and an area 620 of the second object is wider than the area 610 of the first object and narrower than the area 630 of the third object.

Therefore, the motion depth extractor 123 detects that an area parameter AS1 of the first object is smallest, an area parameter AS3 of the third object is greatest, and an area parameter AS2 of the second object has a value between the area parameters AS1 and AS3 of the first and third objects. For example, the motion depth extractor 123 detects the area parameter AS1 of the first object as “3,” the area parameter AS2 of the second object as “7,” and the area parameter AS3 of the third object as “10.”

Referring to FIG. 2 again, the motion depth extractor 123 extracts the motion depth of the object using the relative motion parameter P, a location parameter AP, and an area parameter AS which are detected as described above. Here, the motion depth extractor 123 gives a weight to at least one of the relative motion parameter P, the location parameter AP, and the area parameter AS to extract the motion depth.

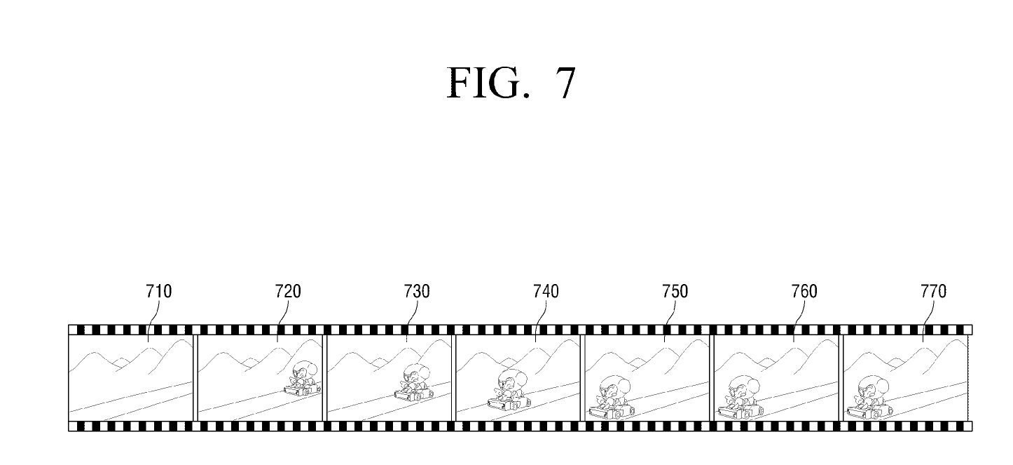

If there are no global and local motions, the motion depth extractor 123 extracts the motion depth using a motion depth value of a previous frame. This will now be described with reference to FIG. 7.

As shown in FIG. 7, first through fifth frames 710 and 750 include motion information of an object, and thus a relative motion parameter is calculated. However, since sixth and seventh frames 760 and 770 do not include local and global motions, a relative motion parameter is “0.” Therefore, the sixth and seventh frames 760 and 770 are to have the same depth as that of the fifth frame 750. However, the sixth and seventh frames 760 and 770 do not have motions and thus have different depth values from their previous depth values.

Accordingly, if there are no local and global motions, the motion depth extractor 123 maintains a motion depth value of a previous frame to extract a motion depth of a current frame. For example, if a relative motion parameter P of the fifth frame 750 is “7,” relative motion parameters P of the sixth and seventh frames 760 and 770 are also maintained to “7.”

Therefore, even if an object that is moving suddenly stops its movement, a depth value does not change. Thus, a viewer is able to view an image of which 3D effect is not distorted.

Referring to FIG. 2 again, the motion depth extractor 123 outputs the extracted motion depth value to the motion depth adjuster 124.

The motion depth adjuster 124 adjusts the motion depth value using at least one of the global and local motions. In more detail, if it is determined that the global motion is great, the motion depth adjuster 124 lowers reliability of the motion depth value. If it is determined that the global motion is small, the motion depth adjuster 124 increases the reliability of the motion depth value. Here, the global motion and the reliability are inversely proportional to each other, and the inverse proportion between the global motion and the reliability may be expressed with various functions having inverse proportion characteristics.

If it is determined that the local motion is great, the motion depth adjuster 124 lowers the reliability of the motion depth value. If it is determined that the local motion is small, the motion depth adjuster 124 increases the reliability of the motion depth value. Here, the local motion and the reliability are inversely proportional to each other, and the inverse proportion between the local motion and the reliability may be expressed with various functions having inverse proportion characteristics.

The motion depth adjuster 124 analyzes a global motion of a specific area of the screen to adjust motion depth reliability of the specific area. In more detail, if it is determined that the global motion of the specific area is great, the motion depth adjuster 124 lowers the motion depth reliability of the specific area. If it is determined that the global motion of the specific area is small, the motion depth adjuster 124 increases the motion depth reliability of the specific area.

The 3D image generator 120 generates a depth map according to motion depth information. If reliability of the motion depth is lower than or equal to a specific threshold value, the motion depth adjuster 124 performs smoothing of the depth map according to the reliability. This is to prevent a 3D effect from being lowered due to irregularities of object shapes caused by the fall in the reliability. However, if the reliability of the motion depth is higher than or equal to the specific threshold value, the motion depth adjuster 124 does not perform smoothing of the depth map.

A depth of an image, which is greatly affected by a motion, is adjusted through an adjustment of reliability of a motion depth, which is performed by the motion depth adjuster 124 according to a global motion, thereby reducing viewing fatigue.

The basic depth extractor 125 extracts the basic depth using the spatial characteristics of the input image which are analyzed by the image analyzer 121. Here, the spatial characteristics may include a color, a contrast, an arrangement between objects, etc.

The depth map generator 126 mixes the motion depth value output from the motion depth adjuster 124 with the basic depth output from the basic depth extractor 125 to generate the depth map of the input image.

The 3D image generator 120 generates a 3D image according to the generated depth map and outputs the 3D image to the image output unit 130.

As described above, a depth value of a 3D image is extracted using various parameters in order to provide a 3D image having a further accurate, high-quality 3D effect to a user.

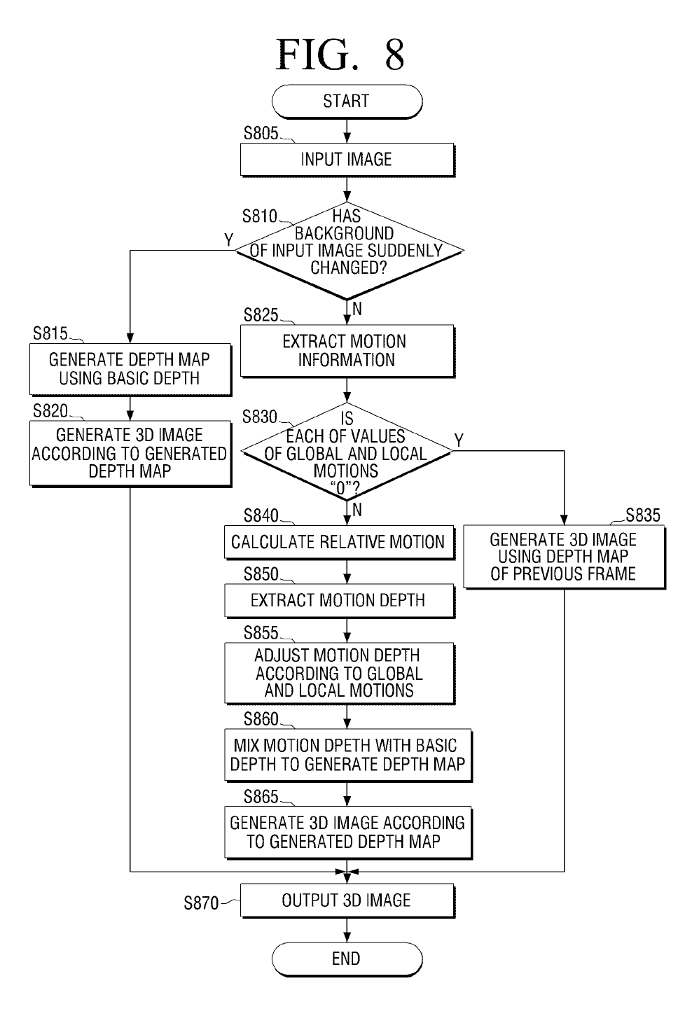

A method for extracting a depth of a 3D image according to an exemplary embodiment will now be described with reference to FIG. 8.

FIG. 8 is a flowchart illustrating a method for extracting a depth of a 3D image in the 3D display apparatus 100, according to an exemplary embodiment.

An image is input into the 3D display apparatus 100 (S805). Here, the input image may be a 2D image or a 3D image.

The 3D display apparatus 100 determines whether a screen of the input image has suddenly changed (S810). The determination as to whether the screen of the input image has suddenly changed may be performed according to whether a pixel included in the screen has changed.

If it is determined that the screen of the input image has suddenly changed (S810-Y), the 3D display apparatus 100 generates a depth map using only a basic depth (S815). This is because a motion depth value becomes a meaningless value if the screen has suddenly changed. The 3D display apparatus 100 generates a 3D image according to the generated depth map (S820). The 3D display apparatus 100 outputs the 3D image (S870).

If it is determined that the screen of the input image has not suddenly changed (S810-N), the 3D display apparatus 100 extracts motion information (S825). Here, the motion information includes global and local motions.

The 3D display apparatus 100 determines whether values of extracted global and local motions are each “0” (S830). If it is determined that the values of the global and local motions are each “0” (S830-Y), the 3D display apparatus 100 generates the 3D image using a depth map of a previous frame (S835). The 3D display apparatus 100 outputs the 3D image (S870).

If it is determined that the values of the global and local motions are not each “0” (S830-N), the 3D display apparatus 100 calculates a relative motion between the global and local motions (S840). Here, the relative motion indicates an absolute value of the relative motion between the global and local motions.

The 3D display apparatus 100 extracts a motion depth using the relative motion (S850). Here, the 3D display apparatus 100 extracts the motion depth in consideration of the relative motion, and a location and an area of an object.

The 3D display apparatus 100 adjusts the motion depth according to at least one of the global and local motions (S855). In more detail, if the global or local motion is great, the 3D display apparatus 100 lowers reliability of the motion depth. If the global or local motion is small, the 3D display apparatus 100 increases the reliability of the motion depth. Therefore, a relation between the motion information and the reliability of the motion depth may be expressed with various functions having inverse proportion characteristics.

The 3D display apparatus 100 mixes the adjusted motion depth with the basic depth to generate the depth map (S860). The 3D display apparatus 100 generates the 3D image according to the depth map (S865) and outputs the 3D image (S870).

As described above, in a 3D display apparatus and a method for extracting a depth of a 3D image of the 3D display apparatus according to the present inventive concept, the depth of the 3D image is extracted using a relative motion between global and local motions of an input image and various parameters. Therefore, a 3D image having a further accurate, high-quality 3D effect is provided to a user.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A three-dimensional (3D) display apparatus comprising:
an image input unit which receives an image;
a 3D image generator which generates a 3D image using a depth information which is obtained from a relative motion between global motions comprising background motion of an object in the image and local motions comprising motion of the object therein and
an image output unit which outputs the 3D image generated by the 3D image generator.

2. The 3D display apparatus as claimed in claim 1, wherein the 3D image generator comprises:
a motion analyzer which extracts global motion information and local motion information of the image;
a motion calculator which calculates the relative motion using an absolute value of a difference between the global motion information and the local motion information; and
a motion depth extractor which extracts a motion depth according to the relative motion.

3. The 3D display apparatus as claimed in claim 2, wherein the 3D image generator further comprises a motion depth adjuster which adjusts reliability of the motion depth according to at least one of the global motion information and the local motion information which are extracted by the motion analyzer.

4. The 3D display apparatus as claimed in claim 3, wherein the 3D image generator generates a depth map using the motion depth, and performs smoothing of the depth map if the reliability of the motion depth is lower than or equal to a threshold value.

5. The 3D display apparatus as claimed in claim 3, wherein the motion depth adjuster lowers the reliability of the motion depth if the global motion increases, and increases the reliability of the motion depth if the global motion decreases.

6. The 3D display apparatus as claimed in claim 5, wherein if the global motion becomes greater only in a specific area of a screen, the motion depth adjuster lowers reliability of a depth of the specific area.

7. The 3D display apparatus as claimed in claim 2, wherein the motion depth extractor extracts the motion depth of the 3D image according to a location and an area of an object located in the image.

8. The 3D display apparatus as claimed in claim 2, wherein if the global and location motions do not exist, the motion depth extractor extracts the motion depth using a motion depth value of a previous frame.

9. The 3D display apparatus as claimed in claim 2, wherein the 3D image generator further comprises:
a basic depth extractor which extracts a basic depth of the 3D image using spatial characteristics of the image; and
a depth map generator which mixes the motion depth extracted by the motion depth extractor with the basic depth extracted by the basic depth extractor to generate the depth map.

10. The 3D display apparatus as claimed in claim 2, wherein the 3D image generator further comprises:
a basic depth extractor which extracts a basic depth of the 3D image using spatial characteristics of the image; and
a depth map generator which generates the depth map using the basic depth without reflecting the motion depth if a degree of change of the image is higher than or equal to a threshold value.

11. The 3D display apparatus as claimed in claim 1, wherein the image is a two-dimensional image.

12. The 3D display apparatus as claimed in claim 1, wherein the image is a 3D image, and the 3D image generator generates the 3D image of which the depth has been adjusted according to the relative motion, using a left or right eye image of the 3D image.

13. A method for extracting a depth of a three-dimensional (3D) image of a 3D display apparatus, the method comprising:
receiving an image;
generating a 3D image of which a depth is adjusted according to a relative motion between global and local motions of the image; and
outputting the 3D image.

14. The method as claimed in claim 13, wherein the generating the 3D image comprises:
extracting global motion information and local motion information of the image;
calculating a relative motion using an absolute value of a difference between the global motion information and the local motion information; and
extracting a motion depth according to the relative motion.

15. The method as claimed in claim 14, wherein the generating the 3D image further comprises adjusting reliability of the motion depth according to at least one of the global motion information and the local motion information.

16. The method as claimed in claim 15, further comprising generating a depth map using the motion depth,
wherein the generating the depth map comprises performing smoothing of the depth map if the reliability of the motion depth is lower than or equal to a specific value.

17. The method as claimed in claim 15, wherein the adjusting the reliability of the motion depth comprises lowering the reliability of the motion depth if the global motion increases and increasing the reliability of the motion depth if the global motion decreases.

18. The method as claimed in claim 17, wherein the adjusting the reliability of the motion depth comprises lowering reliability of a depth of the specific area if the global motion becomes greater only in a specific area of a screen.

19. The method as claimed in claim 14, wherein the extracting the motion depth comprises extracting a motion depth of a 3D image according to a location and an area of an object located in the image.

20. The method as claimed in claim 14, wherein the extracting the motion depth comprises extracting the motion depth using a motion depth value of a previous frame if the global and location motions do not exist.

21. The method as claimed in claim 14, wherein the generating the 3D image further comprises:
extracting a basic depth of the 3D image using spatial characteristics of the image; and
mixing the motion depth with the basic depth to generate a depth map of a 3D image.

22. The method as claimed in claim 14, wherein the generating the 3D image further comprises:
extracting a basic depth of the 3D image using spatial characteristics of the image; and
generating the depth map using the basic depth without reflecting the motion depth if a degree of change of the image is higher than or equal to a threshold value.

23. The method as claimed in claim 13, wherein the image is a two-dimensional image.

24. The method as claimed in claim 13, wherein the image is a 3D image, and the generating the 3D image comprises generating a 3D image of which the depth has been adjusted according to the relative motion, using a left or right eye image of the 3D image.

25. The 3D image display apparatus as claimed in claim 1, wherein the image input unit receives the image from an external device.

26. The 3D image display apparatus as claimed in claim 25, wherein the external device comprises a camera, a display, or a computer.
